(19) United States
(12) Patent Application Publication
(10) Pub. No.: US 2004/0013757 A1
(43) Pub. Date: Jan. 22, 2004

(54) Device for shaping wood-like plate by adhering foaming material

(76) Inventors: Wen-Chang Huang, Chang Hua (TW); Sung-Bo Cheng, Chang Hua (TW)

Correspondence Address: Wen-Chang Huang, 235 Chung - Ho, Box 8-24, Taipei, TW

(21) Appl. No.: 10/199,813

(22) Filed: Jul. 22, 2002

(51) Int. Cl. B29C 47/02

(52) U.S. Cl. 425/113; 425/378.1; 425/380; 425/817 C

(57) ABSTRACT

A device for making a wood-like plate comprises a material receiving mold seat and a material feeding mold seat. A shaping channel is in an inner side of a material receiving mold seat. A material feeding mold seat is located in mold openings of the material receiving mold seat. A plurality of feeding openings is formed longitudinally along the material feeding mold seat for being filled with foaming material. A slit is formed as the material feeding mold seat being located in the material receiving mold seat. A wood texture layer enclosing material feeding mold seat. Heated foaming material is fed into the feeding openings of the material feeding mold seat and outputted from the feeding openings at another side so as to form a shape like the shaping channel. The wood texture layer moves forwards and then encloses the shaped foam plate so as to form a wood-like plate.

### FIELD OF THE INVENTION

The present invention relates to wood-like plates, and particularly to a device for shaping a wood-like plate by adhering foaming material.

### BACKGROUND OF THE INVENTION

For the reason of environmental protection, wood becomes an important resource and is not suitable to various applications. Thereby, wood-like plates are developed, such as wood-like plate made of plastics which is shaped by foaming. Furthermore, the wood has the following disadvantages:

1. The wood is more and more expensive due to resource protection.

2. The finish work is too complex so that the cost is high.

3. Textures and colors of wood plates are not uniform from one to one.

4. The wood is easily deformed due to heat or water.

Although wood-like plate has textures similar to woods, it can not completely like the wood. To increase the hardness of this wood-like plate, in general foaming process is applied to the wood-like plate and a then a wood texture layer is adhere to the plate.

Referring to FIGS. 1, 1A and 1B, in the prior art, a foamed plate 2 is outputted from the material output 31 of a shaping mold 3 and then a wood texture layer is adhered to the plate by a roller G to move Thereby, the surface of the plate.

However, this prior art way is complicated and inconvenient. Thereby, the cost is high. Moreover, the texture layer can not be uniformly adhered to the wood-like plate and bubbles are generated in the texture layer. Thereby, the surface of the plate 2 is uneven. After it is used for a long time, or is placed for a time period, the texture layer P at the corners will be peeled off. Moreover, the corners must be enclosed. This further increases the complexity in packaging.

Moreover, the rolling operation is more suitable for the flat plate surface, but is unsuitable for some decorating strips in the periphery of the plate. Thereby, the manufacturer must added some deocrating strips to match the wood-like plate.

### SUMMARY OF THE INVENTION

Accordingly, the primary object of the present invention is to provide A device for making a wood-like plate comprises a material receiving mold seat and a material feeding mold seat. A shaping channel is in an inner side of a material receiving mold seat. A material feeding mold seat is located in mold openings of the material receiving mold seat. A plurality of feeding openings is formed longitudinally along the material feeding mold seat for being filled with foaming material. A slit is formed as the material feeding mold seat being located in the material receiving mold seat. A wood texture layer enclosing material feeding mold seat. Heated foaming material is fed into the feeding openings of the material feeding mold seat and outputted from the feeding openings at another side so as to form a shape like the shaping channel. The wood texture layer moves forwards and then encloses the shaped foam plate so as to form a wood-like plate.

The various objects and advantages of the present invention will be more readily understood from the following detailed description when read in conjunction with the appended drawing.

### BRIEF DESCRIPTION OF THE DRAWINGS

FIG. 1 is a schematic view showing the shaping and finishing work of a prior art wood.

FIG. 1A is a schematic cross sectional view of a prior art wood adhering work.

FIG. 1B is another schematic cross sectional view of a prior art wood adhering work.

FIG. 2 is a schematic perspective view showing the shape of a wood-like plate of the present invention.

FIG. 2A is a schematic perspective view of the material feeding mold seat of the present invention.

FIG. 3 is a schematic perspective view showing the shaping and adhering process of the wood-like plate of the present invention.

FIG. 4A is a cross sectional view of the shaping mold of the present invention.

FIG. 4AA is used to assist the description of FIG. 4A.

FIG. 4B is a cross sectional view of the shaping mold of the present invention.

FIG. 4BB is an enlarge view for assisting the description of FIG. 4B.

FIG. 4C is another cross sectional view of the shaping mold of the present invention.

FIG. 4CC is an enlarge view for assisting the description of FIG. 4B.

FIG. 4D is a further cross sectional view of the shaping mold of the present invention.

FIG. 4DD is an enlarge view for assisting the description of FIG. 4B.

FIG. 5 is a schematic perspective view showing the shaping and adhering process of the wood-like plate in the second embodiment of the present invention.

FIG. 6 is a perspective view showing a finished product of the second embodiment of the present invention.

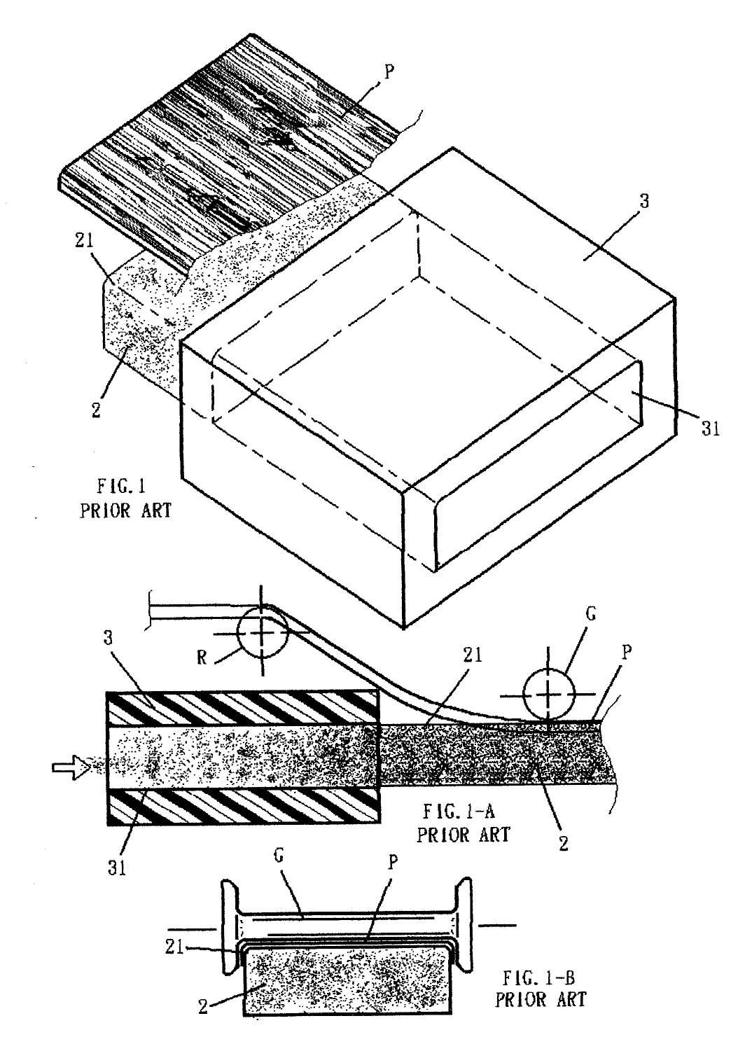

### DETAILED DESCRIPTION OF THE PREFERRED EMBODIMENTS

To be further understood the present invention with the appended drawings.

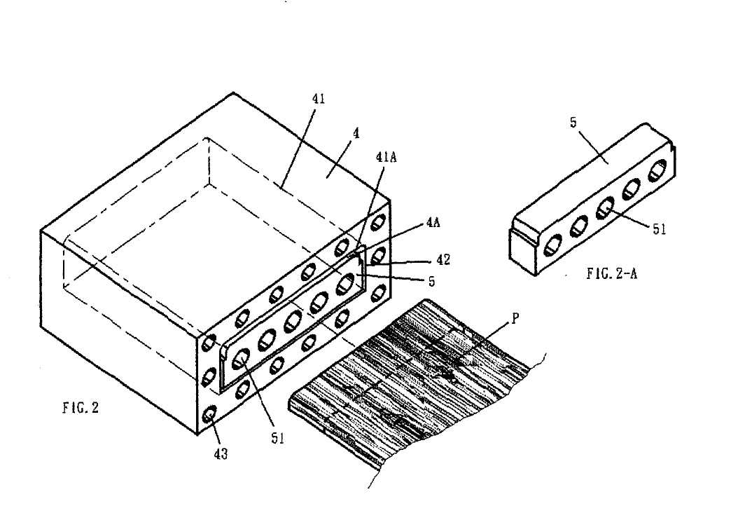

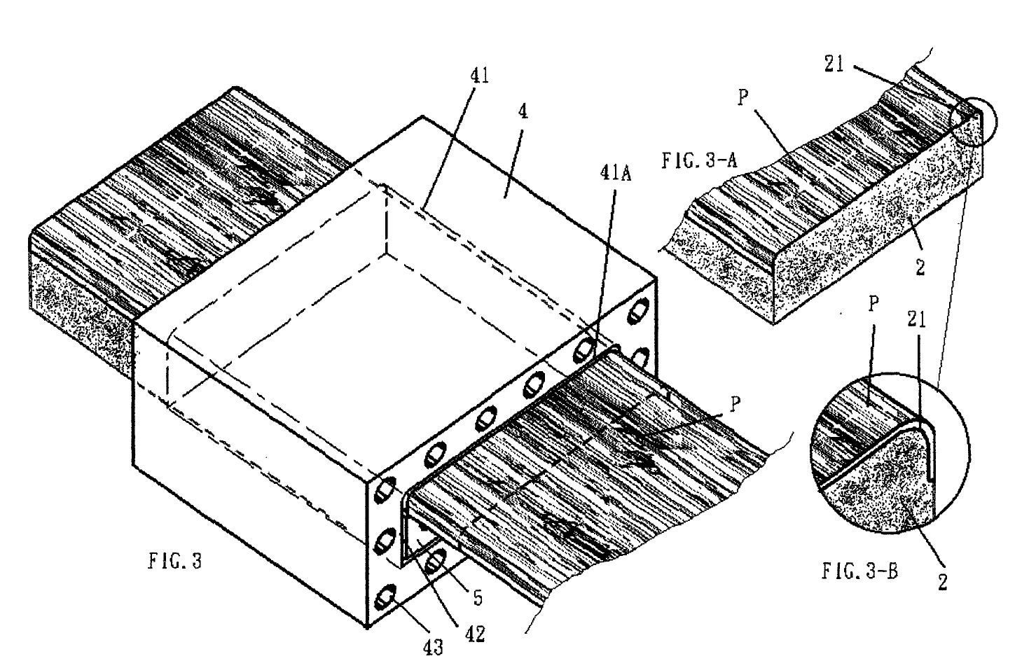

Referring to FIGS. 2, 2A, 3 and 3A, 3B, in the mold structure of the present invention, a shaping channel 41 in the inner side of the material receiving mold seat 4 has a receiving opening 42. A middle section of a material feeding mold seat 5 has a plurality of material feeding openings 51 for guiding foaming material 2A. Then the material feeding mold seat 5 is located in the receiving opening 42 on the material receiving mold seat 4. The material feeding mold seat 5 and material receiving mold seat 4 are formed with a slit 4A. The length of the material feeding mold seat 5 is shorted than the shaping channel 41.

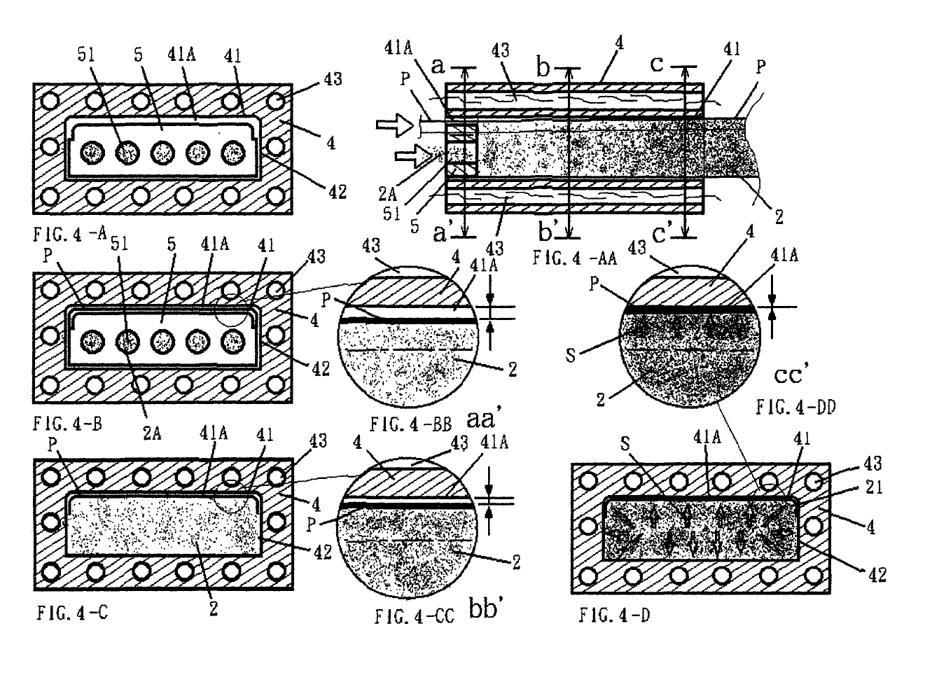

Referring to FIGS. 4A, 4AA, 4B and 4BB. By above mentioned structure, a wood texture layer P is pushed into the pushing mold opening 42 of a slit 4A. After the layer encloses the material feeding mold seat 5, a foaming material is guided into the feeding opening 51 of the material feeding mold seat 5. The feeding opening 51 penetrates through the material feeding mold seat 5. By the foaming effect, the melting foaming material 2A is protruded out from the openings 51 of the material feeding mold seat 5 at another side, then forms a shape like the channel and is tightly adhered on the wood texture layer P. Moreover, by the expanding force S of the material 2A (referring to the arrows in FIGS. 4A and 4DD), the wood texture layer P will resist against the inner surface of the slit 4A in the inner section of the material receiving mold seat 4 (FIGS. 4BB, 4CC and 4DD show the foaming, shaping and adhering processes). The material is formed on the wood-like plate 2 along the shaping channel 41 so as to complete the operation of adhering and flattening the wood texture layer P.

To have a preferred wood-like plate 2, a plurality of cooling channels 43 (gas cooling or water cooling) can be longitudinally arranged in the material receiving mold seat 4. Thereby, the foaming process is slower near the outer side of the shaping channel 41 and is quick near the center portion of the shaping channel 41. Thereby, the foaming rate is high in the inner section so as to have a preferred expansion effect from the inner side to the outer side. Thereby, the floor is shaped along the type of the inner wall of the shaping channel (referring to FIGS. 2, 3 and 4).

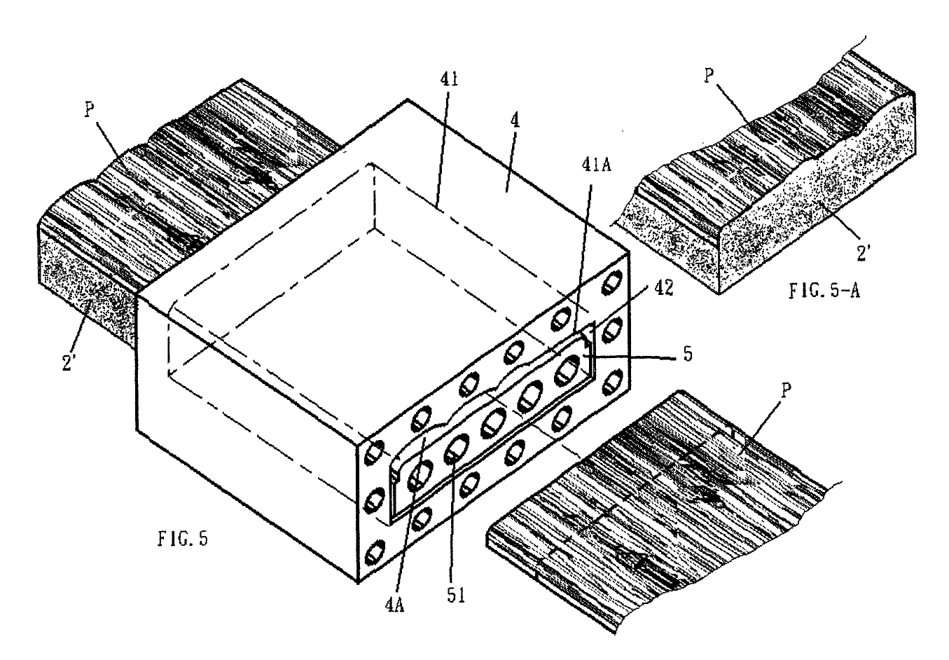

With reference to FIGS. 4 and 5A, in the present invention, the material 2A expands outwards, so that the wood-like plate 2 is shaped along the inner wall of the shaping channel so as to complete the adhering operation of the wood texture layer P. By designing the top surface 41A of the shaping channel 41, the wood texture layer P can be pushed upwards to have a shape same as the top surface 41A. Thereby, the wood-like plate can be formed with decorating strips (or engraved strips). Thereby, the wood texture layer P is well matched to the wood-like plate 2 so as to be used widely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A device for making a wood-like plate by using a shaping mold and a foaming process; the device comprising a material receiving mold seat and a material feeding mold seat; a shaping channel having a mold opening and located in an inner side of a material receiving mold seat; a material feeding mold seat being located within the shaping channel of the material receiving mold seat; a plurality of material feeding openings being formed longitudinally along the material feeding mold seat for being filled with foaming material; a slit is formed between the material receiving mold seat and the material feeding mold seat; and the material feeding mold seat is shorter than the shaping channel;
wherein a wood texture layer enclosing material feeding mold seat; heated foaming material is fed into the feeding openings at one side of the material feeding mold seat and outputted from the feeding openings at another side of the material feeding mold seat so as to form a shape like the shaping channel to be as a shaped foam plate; the wood texture layer moves forwards and then encloses the shaped foam plate; by the foaming effect, the melting foaming material is tightly adhered on the wood texture layer; moreover, by the expanding force of foaming material, the wood texture layer will resist against an inner surface of the slit in the inner section of the material receiving mold seat; the foaming material is adhered to wood-like plate along the channel so as to complete the operation of adhering and flattening the wood texture layer.

2. The device for making a foaming wood-like plate by using a shaping mold as claimed in claim 1, wherein a plurality of cooling channels are longitudinally arranged in the material receiving mold seat; thereby, the foaming process is slow near an outer side of the shaping channel and is quick near a center portion of the shaping channel.

3. The device for making a foaming wood-like plate by using a shaping mold as claimed in claim 1, wherein the shaping channel has a wave-like shape so that the wood-like plate has a corresponding texture.
